(19) United States
(12) Patent Application Publication
(10) Pub. No.: US 2010/0058157 A1
(43) Pub. Date: Mar. 4, 2010

(54) System And Method For Analyzing A Plurality Of Information Systems

(75) Inventors: Samuel T. Kelly, Greenville, SC (US); Joseph Gregory Moody, Greenville, SC (US); Michael John Poore, Simpsonville, SC (US); Jim Luschowski, Greenville, SC (US); Adam Beasley, Simpsonville, SC (US)

Correspondence Address: MCNAIR LAW FIRM, P.A., P.O. BOX 447, GREENVILLE, SC, 29602-0447, US

(73) Assignee: SAM Group, Inc., Greenville, SC (US)

(21) Appl. No.: 12/552,060

(22) Filed: Sep. 1, 2009

Related U.S. Application Data
(60) Provisional application No. 61/093,398, filed on Sep. 1, 2008.

(51) Int. Cl. G06F 11/07; G06Q 10/00; G06Q 20/00; G06Q 30/00

(52) U.S. Cl. 714/819; 705/30; 705/7; 705/21; 714/E11.024

(57) ABSTRACT

A system for analyzing an information system comprising a computer readable medium; and a set of computer readable instructions embodied in the computer readable medium for transmitting an audit application to a first store controller so that the audit application can generate audit data representing audit information from the first store controller, receiving audit data from the first store controller, transmitting an audit application to a second store controller so that the audit application can generate audit data representing audit information from the second store controller, receiving audit data from the second store controller, determining a comparison basis according to the audit information from the first store controller, comparing the audit date from the second store controller to the comparison basis, generating a set of comparison data resulting from the comparison, displaying items from the second store controller that are different from the comparison basis.

### CLAIM OF PRIORITY

This application claims priority on U.S. Provisional Patent Application Ser. No. 61/093,398 entitled SYSTEM AND METHOD FOR ANALYZING A PLURALITY OF INFORMATION SYSTEMS filed Sep. 1, 2008.

### FIELD OF THE INVENTION

This invention is directed to a system and method for analyzing multiple information systems and more specifically identifying differences in hardware and software settings and configurations between multiple information systems.

### BACKGROUND OF THE INVENTION

Commerce is fundamentally based upon the sale of goods. Some historians trace commerce to the beginning of the first communications systems in prehistoric times. In modern times, companies are constantly seeking to improve profits by attempting to reduce costs and increase sale prices. Central to these efforts is the point-of-sale system. A point-of-sale system is the support system that tracks, records and otherwise facilitates purchases from goods and service suppliers such as retailers.

In the late 1800's, many retailers were experiencing the same problem; dishonest employees that were pocketing money from customers. To combat this problem, the cash register was invented by James Ritty and he received U.S. Pat. No. 221,360 in 1879. Ritty stated in his patent that it was to accurately ascertain, at a glance, the total receipts taken in by that employee for any given period of time. In 1973, IBM introduced the first computerized electronic cash register which used client-server technology, peer-to-peer communications, and a local area network in its operation. With the introduction of modern computer systems, these point-of-sale systems (POS) began taking on much more functionality than simply accounting for total receipts during a given period of time. Today, POS systems include functionality such as fully integrated accounting system, inventory management, buy forecasting, customer relationship management, service management, and payroll management. POS systems have all but revolutionized the supermarket, restaurant, hotel, casino and other industries in the retail business.

It is also important to note the importance that is associated with check-out lanes remaining open. A single checkout-lane in a single retail store can average thousands of dollars a day in revenues. In the event that the POS system fails so that the store cannot operate its checkout lanes, losses can be in the tens of thousands of dollars per day. Therefore, there is little margin for downtime with POS systems in the retail environment.

A significant benefit of modern POS system is the inclusion of the database. With a database, transactions occurring at the store check-out lane can provide real time information to the back office portion of the POS system so that the POS system can provide immediate inventory information. In a medium to large retail store, there can be twenty to thirty check-out lanes with large retailers having fifty or more check-out lanes. Additionally, there are multiple stores that are serviced from a single distribution center. Therefore, POS system from multiple stores are connected through wide area networks so that a centralized database can facilitate inventory management, purchasing, and other functions using the POS information from each of the stores.

Unfortunately, the increased functionality and complexity of modern POS systems combined with the near zero tolerance for failure has led to the design of POS systems to include primary servers and secondary servers in the store with a central server at the central location. For example, and not by way of limitation, the IBM 4680-4690 Supermarket application can use two store servers (called controllers and generally named CC and DD) installed at each store for redundancy and reduced down time risks. This IBM system includes hundreds of checkout functions, extensive reporting, data capture, accounting and inventory control features, is fully customizable to match store-specific needs and has full-screen Java GUI, electronic marketing and electronic journaling.

When installing a POS system, such as the IBM 4680-4690, it is desirable to have each of the store servers or controllers identical to the other server or controller in that store. Further, it is advantageous to have store servers between different stores, except for store specific items, identical to each other store. One method of accomplishing this is to first install a “model” store where the hardware and software is customized, tested, configured, and made as close as “perfect” as possible. Once this store is established, the store servers are copied, such as by tape, and replicated as subsequent stores so that each store is a duplicate of the model store. Through normal use, the specific store hardware, software, data, settings and configurations almost immediately begin changing. For example, on the model store, the store manager may have a specialty item that is not carried by other stores. Further, employees of the model store most probably do not work in subsequent stores so that the employee file or operator file for each store would be unique for each store. However, the item file for each store may be identical or very close. Therefore, while the majority of the stores can be replications of the model store, there are elements that will be different store to store. Nevertheless, there are many advantages to having each store as identical as possible.

For example, periodically software updates are made to store controllers. When a software update is made, it may be important that that software upgrade is to a store controller that is already running a specific version of software. If the store controller is not running the proper version of software, the upgrade can create significant errors and problems with the store controllers. In the event that the store begins experiencing problems after the software upgrade, troubleshooting can be simplified if it is easy to determine whether the store was running the prior software prior to the upgrade.

In another example, a store that is not using the same prices as the other stores causes operational problems and can undermine customer satisfaction. Insuring that each store is using the proper item record file can significantly improve customer relations since customers can be assured that prices will be consistent across all stores.

A POS system is dynamic by nature, thousands of transactions occur daily and hundreds of store employees can interact with the POS system during the week. Given the complexity and dynamic nature of POS systems, several undesirable events can occur. For example, a store employee can accidentally change a store server setting which can cause system errors, transactions or other events can change the server configuration making it dissimilar to the other stores, or an update or other maintenance activity can fail causing the server to be different from the other stores. When an event such as this causes the store server to deviate from the others, if can be difficult to determine exactly what the deviation is, particularly when the deviation causes an error or other undesirable behavior by the store server.

Therefore, it would be advantageous to be able to determine deviations that one store has from the rest of “like” stores. However, due to the dynamic nature of the retail environment, it is difficult to develop a baseline configuration in which to measure stores. For example, item files can have tens of thousands of goods with a percentage of them being specific to each store. Employee files can be unique to each store and specialty items can be unique to each store. Therefore, it is problematic to develop and maintain a “baseline configuration” that keeps its utility in such a dynamic environment.

Accordingly, it is an object of this invention to provide a system and method for determination deviations in computer systems of one store to another.

It is another object of this invention to provide a system and method for determining deviations without requiring a comparison standard.

### SUMMARY OF THE INVENTION

This invention is a system for determining discrepancies across multiple computer system comprising a computer readable medium in communications with a plurality of computer based point of sale systems; a set of baseline comparison data embodied in the computer readable medium representing standard operational settings for a computer based point of sale system; and, a set of computer readable audit instructions embodied in the computer readable medium that, when executed by a processor, provide the functions of receiving audit information from a plurality of computer based point of sale systems representing the operational settings of the computer based point of sale systems, retrieving the set of baseline comparison data from the computer readable medium, comparing the audit information with the baseline comparison data from each of the plurality of computer based point of sale systems, determining discrepancies between the baseline comparison data audit information and each of the computer based point of sale system's audit information and displaying a set of discrepancy information representing difference between the baseline comparison data and the computer based point of the audit information for each of the computer based point of sale systems.

This invention can also include a set of audit data gathering instructions that, when executed by the processor of the computer based point of sale, provides the functions of gathering audit information from the computer based point of sale system; and, the computer readable audit instructions include instructions for transmitting the set of audit data gathering instructions to each of the computer based point of sale system and transmitting a delete application command to each of the computer based point of sale instructions requesting that each of the computer based point of sale systems delete the set of audit data gathering instructions from each of sale computer based point of sale systems.

This invention can also include a set of performance criteria embodied in the computer readable medium representing operational parameters for the set of computer readable audit instructions; and, the set of computer readable audit instructions include instructions for retrieving the set of performance criteria and the computer readable audit instructions execute according to the set of performance criteria.

This invention can also include a set of audit data gathering instructions that, when executed by the processor of the computer based point of sale system, provides the functions of gathering audit information from the computer based point of sale system and storing the audit data on a computer readable medium carried by each of the computer based point of sale systems.

This set of audit data gathering instructions can also gather audit information during a predetermined period of time. The set of audit data gathering instructions can also include instructions that delete the audit data from the computer readable medium carried by each of the computer based point of sale systems once the audit data is retrieved by the set of computer readable audit instructions.

This invention can also include a set of comparison criteria embodied in the computer readable medium; and, the set of computer readable audit instructions include instructions for determining discrepancies between the baseline comparison data audit information and each of the computer based point of sale system's audit information determine discrepancies according to the set of comparison criteria.

The comparison criteria can also includes criteria for performing comparisons on items taken from the group of computer files, computer hardware, computer hardware configurations, computer software, computer operating systems and computer data files.

The set of computer readable audit instructions can also include instructions for retrieving audit data from one of the plurality of computer based point of sale systems and creating set of baseline comparison data according to the audit data for comparison with the remaining computer based point of sale systems.

The set of computer readable audit instructions can also include instructions for comparing the audit data with the baseline data according to attributes taken from the group of file date, file time, file size and CRC.

The audit data can also contain information from files taken from the group of item record file, item movement file, delayed maintenance control file, manager message file, miscellaneous transaction file, operator authorization file, operation option authorization file, shelf label control file, shelf label data file, tender verification file, and the terminal load file.

The set of computer readable audit instructions can also include instructions for retrieving audit data from a first computer based point of sale systems, retrieving audit data from a second computer based point of sale system and creating set of baseline comparison data according to the audit data retrieved from the first computer based point of sale system and the second computer based point of sale system.

The set of computer readable audit instructions can also include instructions for ignoring discrepancies between the baseline comparison data and the audit data if the discrepancies exceed a predetermined level.

The set of computer readable audit instructions can also include instructions for ignoring discrepancies between the baseline comparison data and the audit data if a predetermined number of computer based point of sale systems have discrepancies that exceed a predetermined level.

The set of computer readable audit instructions include instructions for determining whether the received audit information is from a first type of a computer based point of sale system or a second type of a computer based point of sale system.

The set of computer readable audit instructions can also include instructions comparing the audit information with the baseline comparison data for each of the first type of computer based point of sale systems, retrieving a second set of baseline comparison data from the computer readable medium, comparing the audit information from the second type for computer based point of sale system with the second set of baseline comparison data so that a comparison is provided for the first type and the second type of computer based point of sale systems.

### DESCRIPTION OF THE DRAWINGS

The construction and steps designed to carry out the invention will be described hereinafter, together with other features thereof. Hence the invention will be more readily understood from a reading of the following specification and by reference to the accompanying drawings forming a part thereof, wherein an example of the invention is shown and wherein:

FIG. 1 is a schematic of a hardware configuration of the invention;

FIG. 2 is a flowchart of the invention;

FIG. 3 is a schematic showing aspects of the invention;

FIG. 4 is an illustration of one user interface of the invention;

FIG. 5 is an illustration of one user interface of the invention; and,

FIG. 6 is an illustration of one user interface of the invention.

### DETAILED DESCRIPTION

An object or module is a section of computer readable code embodied in a computer readable medium. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

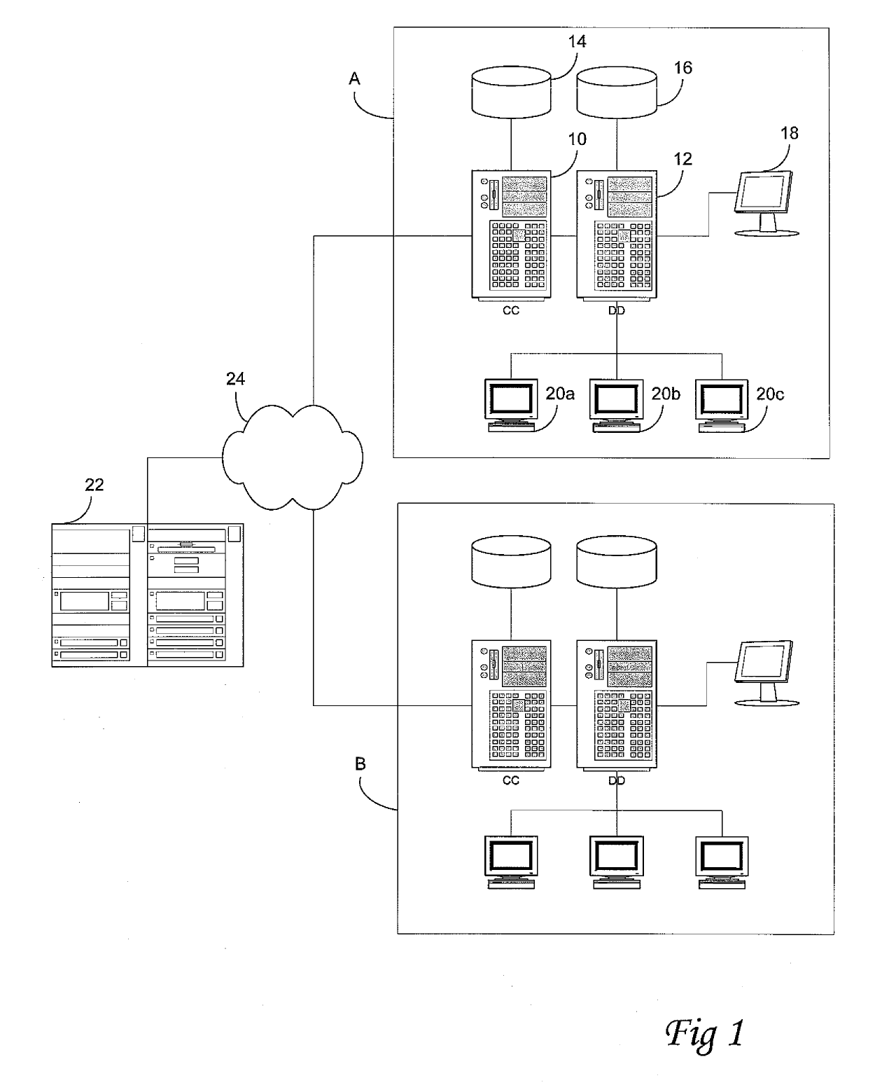

Referring now to FIG. 1, a first store is shown generally at A. Within the store, there is a first controller or server 10 (primary) and a second controller or server 12 (secondary). These store controllers have databases 14 and 16, respectively. The primary and secondary controllers are mirror copies of each other for redundancy and provide a fail-safe process so that if one controller fails, the other can operate the store. One or two of management terminal 18 can be used to access one or more of the controllers at the store. Each store also would have a number of check-out lane registers 20a through 20c. The store controllers can be connected to a central server 22 at a central location through a network 24. In one embodiment, network 24 is a wide area network. With companies with multiple stores, a second store shown generally at B can also be connected to central server 22 through network 24 as well as to the first store A. Store B can have the same hardware as Store A.

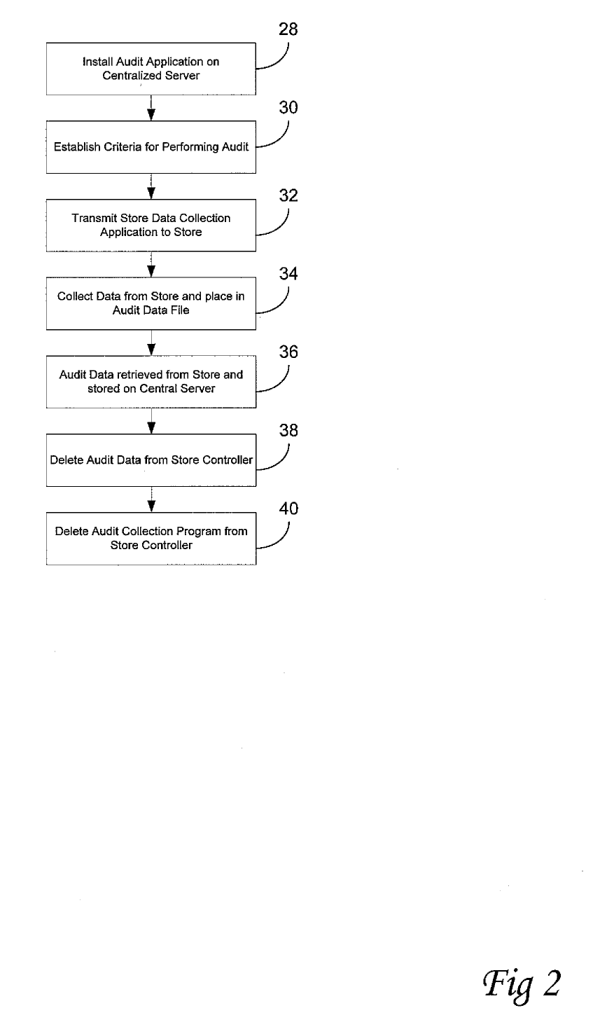

Computer readable instructions reside on central server 22 that provide functionality of this invention. Since the store controllers can have limited resources, such as storage space or memory, the computer readable instructions for performing data collection at the store can be transmitted to the store controller for actuation, then deleted from the store controller once the computer readable instructions have executed. Referring to FIG. 2, this embodiment is described in more detail. The process begins at step 28 where the audit application is installed at the central server. At step 30, performance criteria are entered into the configuration files associated with the audit application. The configuration process can include a multitude of options. For example, a predetermined time can be determined when the audit process will collect information from the store controllers and store check-out terminals.

The configuration process can also include the type of audit to perform. For example, in one embodiment, the audit process uses a selected store for a basis for comparison and compares subsequent store to this base store. In another embodiment, a plurality of stores is used as the basis for comparison. The time period in which information is collected can also be configured. For example, a user can decide to maintain a dynamic comparison base that covers a thirty day period for two stores, a one week period for one store, or a predetermined period for all stores.

In one embodiment, computer readable instructions for performing data collection at the store are transmitted to the store at step 32. At a predetermined time, the store data collection application runs and collects information concerning the store at step 34. This collected information is stored as audit data at the controller to be subsequently retrieved from the central server as in step 36. In one embodiment, the audit data is deleted from the controller once it is retrieved from the central server at step 38. In one embodiment, the audit data is kept in the server and can be deleted after a predetermined period of time.

In one embodiment, the computer readable instructions for performing data collection (audit collection program) is transmitted to the store controllers. The audit collection program, when executed at the store controller, collects audit data. Once the audit collection program completes execution, it can be deleted from the store controller at step 40 to reduce the resource used by the audit process. In one embodiment, the audit collection program is transmitted to the store controller and executed after a predetermined period of time.

Once the audit data is collected at the central server, it is stored on the server computer readable medium for analysis. As part of the analytical process, server computer readable instructions provide the functionality of performing analysis tasks on the audit data. Audit data can include data from one store or multiple stores. The audit data can be segmented by hours, days, or multiple days.

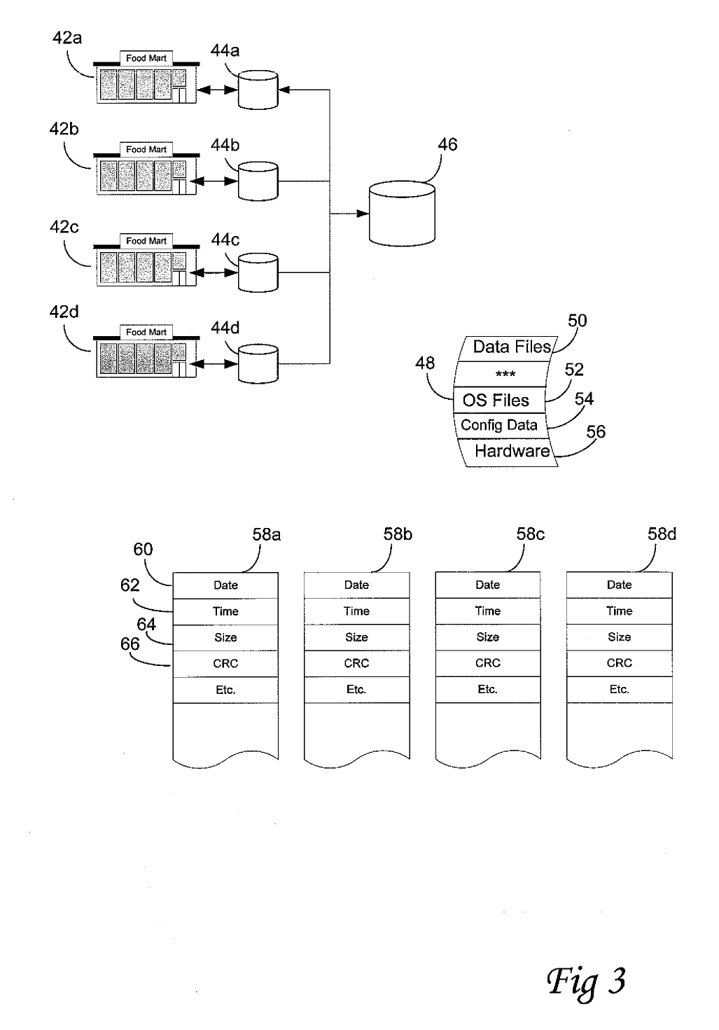

Referring now to FIG. 3, the analysis process is described in more detail. In order to perform the analysis on the audit data, there needs to be a basis for comparison in which to compare the data from the target stores. Therefore, step 42 shows where the comparison basis creation criteria are received at the server. The basis for comparison creation criteria represent the methods in which the comparison basis is generated. A use can create a configuration set which is the information used by the invention to determine what files, hardware, software, operating system, etc. to analyze. For example, the configuration set can include information representing that the system files and the data files of the computer system that are to be analyzed. This allows the user to determine what aspects of a computer system should be analyzed.

In one embodiment, the information from a single day of a store is used to create the comparison standard. In this embodiment, the collected audit data from a particular day is used as the comparison basis and therefore allows other stores to be compared to this basis. Audit data is collected from stores and compared to the basis during the analysis process. The analysis process takes each item in the audit data and from the basis and compares them respectively. By way of example, the date, time, size, and CRC and of the item files can be used for comparison. If these items match, then there is an assurance that the item file at each store is the same so that the store does not have a different or out of date item file. In the event that the item files are shown to be different, corrective measures can be taken such as installing the correct item file that can resolve any errors presented when using an incorrect item file.

In one embodiment illustrated in FIG. 3, the comparison basis is generated on the fly. There are significant advantages to this embodiment since it does not require maintaining a comparison basis for store comparisons. In this embodiment, several stores are selected to be analyzed shown as 42a through 42d. Each of these stores has associated audit data shown as 44a through 44d, respectively, and that has been collected to a centralized server on a centralized storage medium 46. The audit data 48 can include data files 50 such as the following files used with IBM's 4680/4690 Supermarket Application: the item record file, item movement file, delayed maintenance control file, manager message file, miscellaneous transaction file, operator authorization file, operation option authorization file, shelf label control file, shelf label data file, tender verification file, and the terminal load file. The OS files 52 can include logical file names, operating system files such as .dat, .186, j86 and .286 files in the case of the IBM 4680/4690 operating system, log files, system utilities, error messaging files, dump files, remote operator features, EFT user exits, tape device messages, printer files, TCP/IP, LAN, SMA and network files, other files such as those listed in the Dec. 6, 2007, IBM 4690 Programming Guide Version 5.2. The configuration data 54 can include number of store controllers, terminal devices, system-wide functions, and other data resulting from the configuration of a store. Hardware data 56 can include information such as the BIOS date and version, HHD make, model and size, NIC model, amount of RAM, terminal information, printer information, terminal keyboard type and model, terminal display type and model, shopper display type and model, multiple controller feature information and file distribution features.

By way of example, the invention will be illustrated using the Item Record File for the IBM 4680-4690 Supermarket Application. The Item Record File (EAMITEMR) that is described in IBM publication SC30-3634-03 beginning on page 497. During the audit collection process, information concerning the Item Record File is collected from each store 42a through 42d. Audit data for the item file can include the date, time, file size, and CRC for that store's Item Record File. The CRC is the cyclic redundancy check and error checking code that creates a unique number based upon attributes of the file underlying the CRC calculation. In the present example, audit data for each store is shown as 58a through 58d. During the analysis of the audit data, a comparison of the file attributes is made between the audit data 58a through 58d.

For example, the date 60 can be compared between each of the Item Record File attributes 58a through 58d. If the date of Item Record Files 58a through 58c is Jan. 1, 2008 but the date of Item Record File 58d is Nov. 12, 2007, the Item Record File from store 42d is most likely out of date and should be investigated. Other attributes that can be associated with a file include time 62, file size 64, and CRC 66. The audit information representing settings of the majority of Item Record Files can be termed the baseline operational setting. Baseline operational setting can include each component of the point of sale system that can be compared.

In the situation where the Item Record File is correct and up to date, the audit data of each store's Item Record File should match. When the attributes match, it indicates that the four stores have four Item Record Files are current and up-to-date. In the event that there is one Item Record File's attributes that do not match the other three, it indicates that there is a modified, outdated or otherwise different Item Record File at that store. This is an indicator that there needs to be further investigation into that store's Item Record File to determine why the Item Record File is different. Therefore, this invention can provide significant advantages for problem solving and error detecting automated systems between multiple stores. Advantageously, this invention allows such analysis between stores without having to have any prior information concerning the files being compared.

In performing the analysis, in one embodiment a comparison analysis is used. By way of example and not limitation, the IBM 4680/4690 system includes a “File Distribution” attribute for each file on the computer system. There are only five acceptable values for this attribute. When this file exists on more than one system, the File Distribution attribute for this file should be the same across each system. In order to determine whether the File Distribution attribute is the same across all systems, the present invention can retrieve from the File Attribute from the target file being analyzed, compare this File Distribution attribute with the attribute included in the comparison basis and make a determination that the File Distribution attribute is the same. If it is not, the present invention can provide notification to a user that there is an inconsistency between this attribute across locations and systems.

On one embodiment, a deviation analysis can be used. In this embodiment, audit data is collected over some period of time. The attribute associated with the item analyzed is compared with previous audit data and while the attribute may change from data set to data set, but may not be changing consistently. By way of example and using the 4680/4690 operating system as an example, the store operator may determine that the “Cash Back” limit for checks should be $25.00. This attribute is set in the Terminal Options accordingly. When audits are performed, the value in the Terminal Options remains consistent over the course of several days. However, in one subsequent audit, the attribute in Terminal Options moves to $250. This is considered a deviation from the previous audit data information showing no change and therefore the invention will notify the user that there is a deviation. It is an advantage of this invention that the actual amount set for an attribute, such as the $25 “Cash Back” in the above example, need not be any particulate value since the analytical process do not value dependent for the actual value in any field or attribute of the item being analyzed.

Computer systems, including point-of-sale systems, include a significant number of files. Further, in the point-of-sale environment, there are many files that are unique to each store. As such, comparing these store unique files between stores has less utility than when comparing files that should be constant across each store. For example, the Operator Authorization File contains record entries for each of the operators for the store. It is common for one store to have a different set of employees than the other stores. Therefore, it would not be uncommon that a comparison between stores should lead to the results that each operator authorization file was different between each store. Therefore, this invention can determine when there are too many differences across stores for such a file that the file is excluded from the analysis. Again, there is no need for any predetermined standard of file listing or other information prior to performing the analysis. This invention can compare the information between stores based upon the information contained in the audit data collected from each store.

By way of example, if something is the same on 90% of the stores, it is most likely that it should be the same across all stores. The invention automates the process of finding these differences or similarities between multiple stores. An advantage realized from the invention is that the user need not perform the tedious task of comparing multiple stores and removing piece-by-piece the unimportant audited items that should be different from store to store.

In one embodiment, threshold values are set to determine how many matches and/or mismatches across the data set make an auditable element relevant. Those that fall outside of the defined ranges can be automatically discarded thereby reducing the amount of initial data the user is presented. For example, if one store is experiencing a problem, the user can select other stores, (four for example) that are not experiencing the same problem. Based on threshold settings, the invention can discard everything that is different across all of the selected stores. It can also keep those things that are the same in 90% of the comparison stores and then compare what is left with the problem store, potentially exposing the issue.

In one embodiment, the store to be analyzed and the stores used for comparison can be configured. For example, there is a problem with items not being properly priced at store 42d. Therefore, the invention can be configured to use stores 42a through 42c to create the comparison basis. The comparison basis can be created when audit data from stores 42a through 42c is analyzed and a determination is made as to which files are similar between the stores and which should be discarded as unique files to each store. Once this process is completed, the resulting files can be compared to the audit data from store 42d. In one case, the Item Record File attributes 58d may show that the Item Record File from Store 42d is out of date and needs to be updated. Therefore, this invention allows for the determination of remedial action very quickly and by using existing store data without the need for pre-existing information about the stores.

In another embodiment, the analysis can be performed for each day over a certain period of time. This function is helpful when the issue that is trying to be resolved is known to have occurred at a particular time or generally around a particular time. For example, if a problem with the Item Record File begins presenting itself on a Thursday, the invention can perform the analysis on the Item Record File for that store for the preceding few days. This can identify the potential cause for the problem that can then be addressed. By performing the analysis for each of the preceding days, it may be that information can be learned that will help in determining the cause of any issues. For example, the following information may be determined from an analysis of the Item Record File occurring over several days:

TABLE 1

| | | | |
|---|---|---|---|
| Store 42a | Store 42b | Store 42c | Store 42d |

Day 1 Monday

| | | | | |
|---|---|---|---|---|
| Date | 12/15 | 12/15 | 12/15 | 12/15 |
| Time | 15:12:45 | 15:12:45 | 15:12:45 | 15:12:45 |
| Size | 151MB | 151MB | 151MB | 151MB |
| CRC | f4b5dce321 | f4b5dce321 | f4b5dce321 | f4b5dce321 |

Day 2 Tuesday

| | | | | |
|---|---|---|---|---|
| Date | 12/15 | 12/15 | 12/15 | 12/15 |
| Time | 15:12:45 | 15:12:45 | 15:12:45 | 15:12:45 |
| Size | 151MB | 151MB | 151MB | 151MB |
| CRC | f4b5dce321 | f4b5dce321 | f4b5dce321 | f4b5dce321 |

Day 3 Wednesday

| | | | | |
|---|---|---|---|---|
| Date | 1/2 | 1/2 | 12/15 | 1/2 |
| Time | 09:08:43 | 09:08:43 | 15:12:45 | 09:08:43 |
| Size | 158MB | 158MB | 151MB | 158MB |
| CRC | d3feg52h | d3feg52h | f4b5dce321 | d3feg52h |

Day 4 Thursday

| | | | | |
|---|---|---|---|---|
| Date | 1/2 | 1/2 | 12/15 | 1/2 |
| Time | 09:08:43 | 09:08:43 | 15:12:45 | 09:08:43 |
| Size | 158MB | 158MB | 151MB | 158MB |
| CRC | d3feg52h | d3feg52h | f4b5dce321 | d3feg52h |

Day 4 Friday

| | | | | |
|---|---|---|---|---|
| Date | 1/2 | 1/2 | 1/2 | 1/2 |
| Time | 09:08:43 | 09:08:43 | 09:08:43 | 09:08:43 |
| Size | 158MB | 158MB | 158MB | 158MB |
| CRC | d3feg52h | d3feg52h | d3feg52h | d3feg52h |

As can be seen on Table 1, the file attributes for the Item Record File are identical for stores 42a through 42d on Day 1—Monday. Further, the attributes remain identical on Day 2—Tuesday. However, on Day 3—Wednesday store 42a, 42b and 42d all show that the date of the Item Record file is January 2 and not the previous date of December 15. Additionally, store 42c also shows that the file size of the Item Record file is still 151 MB while the other stores show an Item Record File of 158 MB. This information indicates that on Day 3 there was some modification to the Item Record File at stores 42a, 42b and 42d that did not occur at store 42c. Therefore, this is an indication that at store 42c, there is an out of date or otherwise undesirable Item Record File and the issue should be remedied. On Day 4, however, it seems that the Item Record File for store 42c was updated and therefore the file attributes of store 42c match the other stores. This indicated that the Item Record File was updated, but not in conjunction with the other three stores. This information can help identify a potential problem with the file update process for store 42c. Again, this analysis can be performed without the need for any information prepared prior the analytical process.

The scope of the invention also covers the ability to analyze system information that is more than the files of the system. For example, the attributes associated with the hardware can also be analyzed by this invention. The following information can be collected by the audit collection process and used to analyze the hardware configuration of the particular store.

TABLE 2

| | | | |
|---|---|---|---|
| Store 42a | Store 42b | Store 42c | Store 42d |

Day 1 Monday

| | | | | |
|---|---|---|---|---|
| HHD Size | 80 Gig | 80 Gig | 80 Gig | 80 Gig |
| RAM | 1.2 Gig | 1.2 Gig | 1.2 Gig | 1.2 Gig |

Day 2 Tuesday

| | | | | |
|---|---|---|---|---|
| HHD Size | 80 Gig | 80 Gig | 80 Gig | 80 Gig |
| RAM | 2.4 Gig | 2.4 Gig | 1.2 Gig | 2.4 Gig |

Based upon the information shown above, it can be seen that each store had 1.2 Gig of RAM on Day 1. On Day 2, stores 42a, 42b and 42d show that the RAM increased for the store controllers to 2.4 Gig. However, store 42c shows no increase in the RAM. This indicates that store 42c did not receive the proper upgrade to memory.

In one embodiment, the information that is audited includes hardware information for the 4680-4690 store controllers including drive partitions and system memory; file system information such as directory and file information; operating system information such as processes and logical file names; pluggable user exits that are added for customization of the application; store and terminal options; .ini file information; keyed file information; operator information; hidden options; and EFT related information. This information, while described in the 4680-4690 environments, can also be applied to non-IBM point-of-sale systems.

In one embodiment, the invention can be used to compare the controller information between the CC and DD controllers of the 4680-4690 system; compare a store that is having problems against several that are not; compare files between two stores to verify that all applications are the same; validate that all files and settings from an ASM were deployed properly; verify and report for compliance directed to the software and settings for each store; compare day to day changes made to a lab system; proactively validate software/setting levels at the store with automated notification (email etc.) when differences are detected.

By way of example and not limitation, in the 4680/4690 operating system using the IBM application Supermarket, the following files can be audited:

TABLE 3

| Audit | | |
|---|---|---|
| Collection | Audit Element | Audit Attribute |
| Hardware | Drive Partition | User Raw Set Allowed |
| | | User Raw Write Allowed |
| | | User Raw Read Allowed |
| | | Removable Device Driver |
| | | DEVLOCK Allowed |
| | | Partitioned Disk Driver |
| | | Verify Disk Writes |
| | | Locked to Process |
| | | Locked to Family |
| | | Opened as Attribute |
| | | In Use by Process |
| | | Activated for File System |
| | | Files on Disk |
| | | Family Node ID |
| | | Network Node ID |
| | | Process ID |
| | | Free Space on Disk/Partition |
| | | Total File Space on |
| | | Disk/Partition |
| | | Sector Size |
| | | First Sector of Logical Media |
| | | Sectors on Disk |
| | | Sectors Per Track |
| | | Sectors Per Block |
| | | FATs |
| | | Media Format |
| | | Sectors Per FAT |
| | | Max Directory Entries |
| | | Heads on Disk |
| | | RAW Format |
| | | File System Type |
| | | System Area Size |
| | | Hidden Sectors on Partition |
| | | Label Flag |
| | | File Security |
| | | Uppercase Names Only |
| | | User ID |
| | | Group ID |
| | | Label |
| | Memory | Total Memory |
| | | Size of System Memory |
| | | Total Free Memory |
| File System | File | Read Only |
| | | Hidden |
| | | System |
| | | Archive |
| | | File Distribution |
| | | User |
| | | Group |
| | | Owner Delete |
| | | Owner Execute |
| | | Owner Write |
| | | Owner Read |
| | | Group Delete |
| | | Group Execute |
| | | Group Write |
| | | Group Read |
| | | World Delete |
| | | World Execute |
| | | World Write |
| | | World Read |
| | | No Security |
| | | Size |
| | | Date |
| | | Time |
| | | CRC |
| Operating | System Info | CPU Type |
| System | | OS Type |
| | | File Tables |
| | | Max File Tables |
| | | Max Files Per Table |
| | | Open Files the System Can |
| | | Support |
| | | Max Open Files the System Can |
| | | Support |
| | Processes | Process Name |
| | | Parameters |
| | | ID |
| | | Family ID |
| | | CDN |
| | | VCN |
| | | State |
| | | Priority |
| | | Max Memory Allowed |
| | | System Process |
| | | Locked |
| | | SWI Context |
| | | Privileged |
| | | User Number |
| | | Group Number |
| | | Parent ID |
| | | Completed Events |
| | | Code Area |
| | | Code Size |
| | | Data Area |
| | | Data Size |
| | | Heap Area |
| | | Heap Size |
| | LFN | LFND |
| Tax Tables | General | Description |
| | | Start of Repeat Range |
| | | Tax on First Range |
| | Tax Range | Amount of Sale |
| | | Amount of Tax |
| ACE Person- | All of ACE | All |
| alization | | |
| SA Person- | Store Options | All of Store Options |
| alization | Terminal Options | All of Terminal Options |
| Configura- | All INI (.ini) | |
| tion Files | All Properties (.pro) | |
| SAM Options | Enabled | |
| | Disabled | |

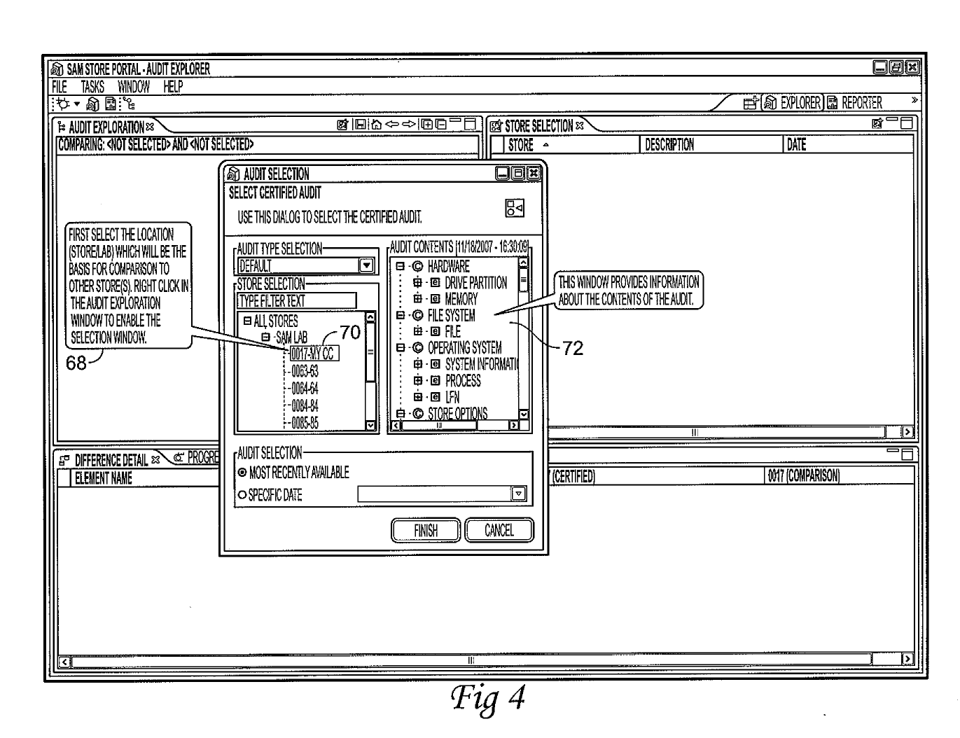

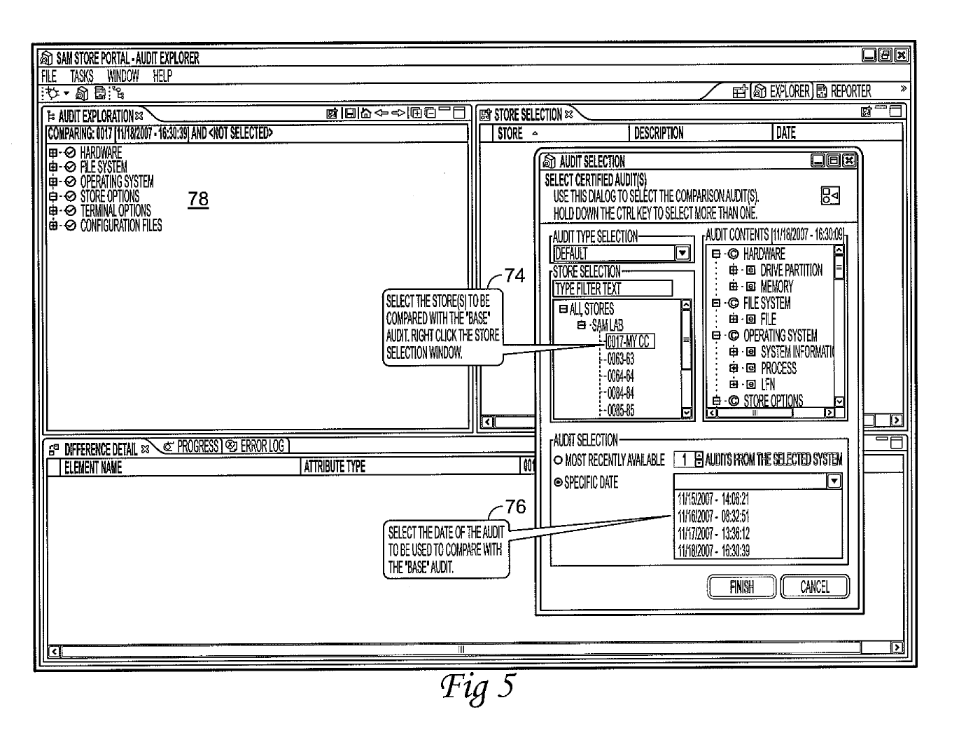

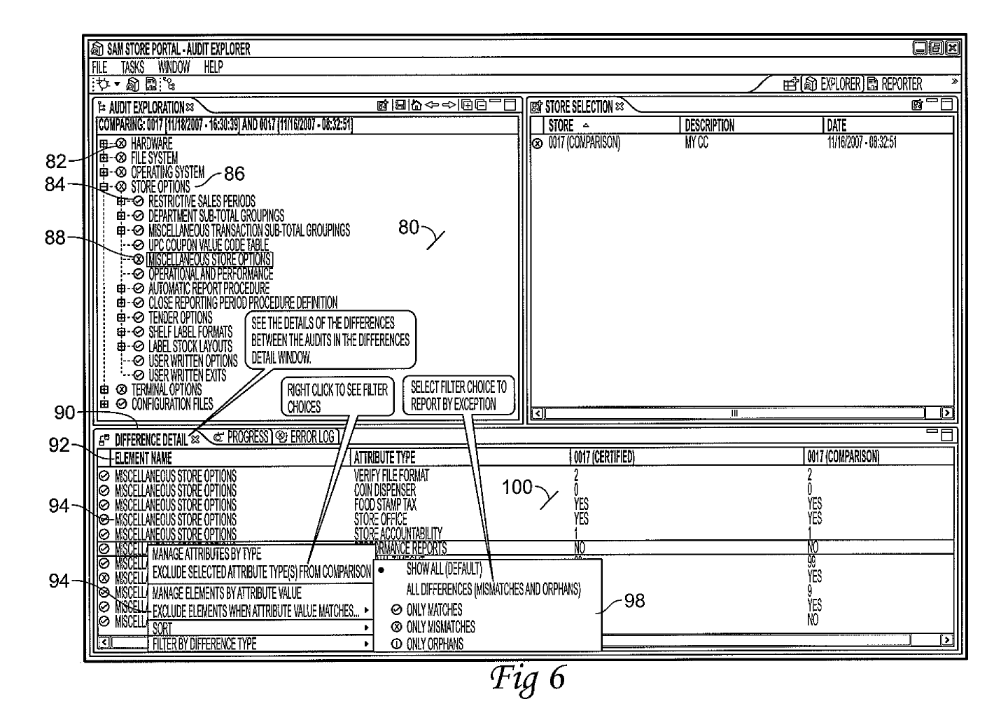

When the analysis is completed, the invention can provide an “at a glance” view of the results. Referring to FIG. 4, an example of the user display is illustrated. At 68, the user selected the store that will be the “base” store to be used for comparison to the target store. This is the target store where an analysis is desired. In this example, store 70 (0017 My CC) is selected. The display can also provide to the user the information that is contained in the audit information shown at 72. Referring now to FIG. 5, the user then selects the target store at 74. The date for the audit data to be used is selected at 76. It should be noted that the display shows information categories for the comparison data at 78. Once the selections are made, the results of the comparison are illustrated in FIG. 6.

Referring to FIG. 6, the display illustrating the audit results is shown. As can be seen, the window area shown generally as 80 shows the items of the store system that were compared. For example, the first entry shows that hardware was part of the comparison. Indicator 82 shows that there were items under the hardware category that were different between the two compared sets of audit data. In one embodiment, this indicator is a red icon with an X in the center. This category can be expended or collapsed using the plus icon shown to the left of the “Hardware” label. In the event that there are no differences between compared items, an icon shown as 84 can be used to show there were no differences. In one embodiment, the icon is a green circle with a check mark generally in the center of the circle.

By way of example, item 86 is for Store Options. When expanded, the category Store Options, additional sub-categories are revealed. For example, Miscellaneous Store Options 88 is shown. The icon on the left of the sub-category indicates that during the analysis, differences between the base store and the target store were discovered. In display area 90, the details of the difference discovered can be viewed. The element of the sub-category is shown in list 92. Element 94 shows that Miscellaneous Store Option: Store Office contains the value in the base store and the target store. In one embodiment, the base store is a certified store that is used for comparison with target stores.

Additionally, functionality provided by the computer readable instructions includes instructions for applying a filter to the list of elements displayed. Upon actuation, the display provides options 96 associated with the element that allows filtering of the element list. In one embodiment, filtering can be by matches, mismatches or orphans as shown at 98. Orphans are elements or items that appear at the base store or target store, but do not appear at the other store. Area 100 shows the values of the base store and the target store for each element under the sub-category. Area 102 shows a list of target stores. In this example, the audit data from store 0017 dated Nov. 16, 2007 was compared with the audit data from the same store, but dated Nov. 18, 2007. In one embodiment, multiple stores will be listed in areas 102 and the comparison will not be with different dates of the same store, but with the same date from different stores.

In one embodiment, this invention can perform analysis over several stores that are dissimilar. In some operations, a single location contains several retail operations such as a grocery store and pharmacy. The grocery store portion of the operations can have a store controller while the pharmacy portion of the operation can have a separate store controller. The audit collection process can collect audit data from both the grocery and pharmacy controllers. During the analysis process, the computer readable instructions can determine that there are two types of stores and can group the audit data accordingly. This determination can be made by file name or other file attributes so that the grouping can be made. Once the audit data is grouped, the analysis can be provided to the user and the analysis performed for each store type. Therefore, this invention can compare stores to a comparison basis that is based upon each type of store determined during the analysis process. This allows the invention to provide analysis for store even when multiple types of stores with different file systems, hardware and software depending upon the store type.

This invention has been described in a manner to allow one skilled in the art to understand and practice the invention. The examples and embodiments used in this description are not to be used to limit the scope of the following claims.

What is claimed is:

1. A system for determining discrepancies across multiple computer system comprising:
a computer readable medium in communications with a plurality of computer based point of sale systems;
a set of baseline comparison data embodied in said computer readable medium representing standard operational settings for a computer based point of sale system; and,
a set of computer readable audit instructions embodied in said computer readable medium that, when executed by a processor, provides the functions of receiving audit information from a plurality of computer based point of sale systems representing the operational settings of said computer based point of sale systems, retrieving said set of baseline comparison data from said computer readable medium, comparing said audit information with said baseline comparison data from each of said plurality of computer based point of sale systems, determining discrepancies between said baseline comparison data audit information and each of said computer based point of sale system's audit information, and displaying a set of discrepancy information representing difference between said baseline comparison data and said computer based point of said audit information for each of said computer based point of sale systems.

2. The system of claim 1 including:
a set of audit data gathering instructions that, when executed by the processor of said computer based point of sale, provides the functions of gathering audit information from said computer based point of sale system; and,
said computer readable audit instructions include instructions for transmitting said set of audit data gathering instructions to each of said computer based point of sale system and transmitting a delete application command to each of said computer based point of sale instructions requesting that each of said computer based point of sale systems delete said set of audit data gathering instructions from each of sale computer based point of sale systems.

3. The system of claim 1 including:
a set of performance criteria embodied in said computer readable medium representing operational parameters for said set of computer readable audit instructions; and,
said set of computer readable audit instructions include instructions for retrieving said set of performance criteria and said computer readable audit instructions execute according to said set of performance criteria.

4. The system of claim 1 including a set of audit data gathering instructions that, when executed by the processor of said computer based point of sale system, provides the functions of gathering audit information from said computer based point of sale system and storing said audit data on a computer readable medium carried by each of said computer based point of sale systems.

5. The system of claim 4 wherein said set of audit data gathering instructions gather audit information during a predetermined period of time.

6. The system of claim 4 wherein said set of audit data gathering instructions include instructions that delete said audit data from said computer readable medium carried by each of said computer based point of sale systems once said audit data is retrieved by said set of computer readable audit instructions.

7. The system of claim 1 including:
a set of comparison criteria embodied in said computer readable medium; and,
said set of computer readable audit instructions include instructions for determining discrepancies between said baseline comparison data audit information and each of said computer based point of sale system's audit information determine discrepancies according to said set of comparison criteria.

8. The system of claim 7 wherein said comparison criteria include criteria for performing comparisons on items taken from the group of computer files, computer hardware, computer hardware configurations, computer software, computer operating systems and computer data files.

9. The system of claim 1 wherein said set of computer readable audit instructions include instructions for retrieving audit data from one of said plurality of computer based point of sale systems and creating set of baseline comparison data according to said audit data for comparison with the remaining computer based point of sale systems.

10. The system of claim 1 wherein said set of computer readable audit instructions include instructions for comparing said audit data with said baseline data according to attributes taken from the group of file date, file time, file size and CRC.

11. The system of claim 1 wherein said audit data contains information from files taken from the group of item record file, item movement file, delayed maintenance control file, manager message file, miscellaneous transaction file, operator authorization file, operation option authorization file, shelf label control file, shelf label data file, tender verification file, and the terminal load file.

12. The system of claim 1 wherein said set of computer readable audit instructions include instructions for retrieving audit data from a first computer based point of sale systems, retrieving audit data from a second computer based point of sale system and creating set of baseline comparison data according to said audit data retrieved from said first computer based point of sale system and said second computer based point of sale system.

13. The system of claim 1 wherein said set of computer readable audit instructions include instructions for ignoring discrepancies between the baseline comparison data and the audit data if said discrepancies exceed a predetermined level.

14. The system of claim 1 wherein said set of computer readable audit instructions include instructions for ignoring discrepancies between the baseline comparison data and the audit data if a predetermined number of computer based point of sale systems have discrepancies that exceed a predetermined level.

15. The system of claim 1 wherein said set of computer readable audit instructions include instructions for determining whether said received audit information is from a first type of a computer based point of sale system or a second type of a computer based point of sale system.

16. A system of claim 15 wherein said set of computer readable audit instructions include instructions comparing said audit information with said baseline comparison data for each of said first type of computer based point of sale systems, retrieving a second set of baseline comparison data from said computer readable medium, comparing said audit information from said second type for computer based point of sale system with said second set of baseline comparison data so that a comparison is provided for said first type and said second type of computer based point of sale systems.

17. A system for determining discrepancies across multiple computer systems comprising:
a computer readable medium in communications with a plurality of computer based point of sale systems; and,
a set of computer readable audit instructions embodied in said computer readable medium that, when executed by a processor, provide the functions of receiving audit information from a plurality of computer based point of sale systems representing the operational settings of said computer based point of sale systems, determining a set of baseline operational settings according to said audit information, comparing said baseline operational setting with each of said audit date of said computer based point of sale systems, determining whether discrepancies exist among said audit data between said baseline operational setting and each of said computer based point of sale system's audit information and displaying a set of discrepancy information representing difference between said baseline operational setting and said computer based point of said audit information for each of said computer based point of sale systems.

18. The system of claim 17 including:
a set of audit data gathering instructions that, when executed by the processor of said computer based point of sale, provides the functions of gathering audit information from said computer based point of sale system; and,
said computer readable instructions include instructions for transmitting said set of audit data gathering instructions to each of said computer based point of sale system and transmitting a delete application command to each of said computer based point of sale instructions requested that each of said computer based point of sale system delete said set of audit data gathering instructions from each of sale computer based point of sale system.

19. The system of claim 17 including:
a set of performance criteria embodied in said computer readable medium representing operational parameters for said set of computer readable audit instructions; and,
said set of computer readable audit instructions include instructions for retrieving said set of performance criteria and said computer readable audit instructions execute according to said set of performance criteria.

20. The system of claim 17 including a set of audit data gathering instructions that, when executed by the processor of said computer based point of sale system, provides the functions of gathering audit information from said computer based point of sale system and storing said audit data on a computer readable medium carried by each of said computer based point of sale systems.

21. The system of claim 20 where said set of audit data gathering instructions gather audit information during a predetermined period of time.

22. The system of claim 20 wherein said set of audit data gathering instructions include instructions that delete said audit data from said computer readable medium carried by each of said computer based point of sale systems once said audit data is retrieved by said set of computer readable audit instructions.

23. The system of claim 17 including:
a set of comparison criteria embodied in said computer readable medium; and,
said set of computer readable audit instructions include instructions for determining discrepancies between said baseline comparison data audit information and each of said computer based point of sale system's audit information determine discrepancies according to said set of comparison criteria.

24. The system of claim 23 wherein said comparison criteria includes criteria for performing comparisons on items taken from the group of computer files, computer hardware, computer hardware configurations, computer software, computer operating systems and computer data files.

25. The system of claim 17 wherein said set of computer readable audit instructions include instructions for comparing said audit data with said baseline data according to attributes taken from the group of file date, file time, file size and CRC.

26. The system of claim 17 wherein said audit data contains information from files taken from the group of item record file, item movement file, delayed maintenance control file, manager message file, miscellaneous transaction file, operator authorization file, operation option authorization file, shelf label control file, shelf label data file, tender verification file, and the terminal load file.

27. The system of claim 17 wherein said set of computer readable audit instructions include instructions for ignoring discrepancies between the baseline comparison data and the audit data if said discrepancies exceed a predetermined level.

28. The system of claim 17 wherein said set of computer readable audit instructions include instructions for ignoring discrepancies between the baseline comparison data and the audit data if a predetermined number of computer based point of sale systems have discrepancies that exceed a predetermined level.

29. A system for determining discrepancies across multiple computer systems comprising:
a computer readable medium in communications with a plurality of computer based point of sale systems; and,
a set of computer readable audit instructions embodied in said computer readable medium that, when executed by a processor, provides the functions of receiving a set of first audit information from a computer based point of sale system representing the operational settings of said computer based point of sale system and a predetermined point in time, receiving a set of second audit information from said computer based point of sale system representing the operational settings of said computer based point of sale system and a subsequent predetermined point in time, comparing said first audit information with said second audit information to determine whether discrepancies exist among said first set of audit data and said second set of audit data and displaying a set of discrepancy information representing difference between said baseline operational settings and said computer based point of said audit information for each of said computer based point of sale systems.

30. The system of claim 29 including:
a set of audit data gathering instructions that, when executed by the processor of said computer based point of sale, provides the functions of gathering audit information from said computer based point of sale system; and,
said computer readable audit instructions include instructions for transmitting said set of audit data gathering instructions to said computer based point of sale system and transmitting a delete application command to said computer based point of sale instructions requesting that said computer based point of sale system delete said set of audit data gathering instructions from said sale computer based point of sale system.

31. The system of claim 29 including:
a set of performance criteria embodied in said computer readable medium representing operational parameters for said set of computer readable audit instructions; and,
said set of computer readable audit instructions include instructions for retrieving said set of performance criteria and said computer readable audit instructions execute according to said set of performance criteria.

32. The system of claim 29 including a set of audit data gathering instructions that, when executed by the processor of said computer based point of sale system, provides the functions of gathering audit information from said computer based point of sale system and storing said audit data on a computer readable medium carried by each of said computer based point of sale systems.

33. The system of claim 32 wherein said set of audit data gathering instructions gather audit information during a predetermined period of time.

34. The system of claim 32 wherein said set of audit data gathering instructions include instructions that delete said audit data from said computer readable medium carried by said computer based point of sale system once said audit data is retrieved by said set of computer readable audit instructions.

35. The system of claim 29 including:
a set of comparison criteria embodied in said computer readable medium; and,
said set of computer readable audit instructions include instructions for determining discrepancies between said first set of audit information and said second set of audit information according to said set of comparison criteria.

36. The system of claim 35 wherein said comparison criteria includes criteria for performing comparisons on items taken from the group of computer files, computer hardware, computer hardware configurations, computer software, computer operating systems and computer data files.

37. The system of claim 29 wherein said set of computer readable audit instructions include instructions for comparing said audit data with said baseline data according to attributes taken from the group of file date, file time, file size and CRC.

38. The system of claim 29 wherein said audit data contains information from files taken from the group of item record file, item movement file, delayed maintenance control file, manager message file, miscellaneous transaction file, operator authorization file, operation option authorization file, shelf label control file, shelf label data file, tender verification file, and the terminal load file.

39. The system of claim 29 wherein said set of computer readable audit instructions include instructions for ignoring discrepancies between said first set of audit data and said second set of audit data if said discrepancies exceed a predetermined level.
